(19) United States
(12) Patent Application Publication
(10) Pub. No.: US 2025/0313038 A1
(43) Pub. Date: Oct. 9, 2025

(54) HUB DEVICE

(71) Applicant: CHENG FENG PRECISION TECHNOLOGY CO., LTD., Taichung City (TW)

(72) Inventor: Chung-Che LEE, Taichung City (TW)

(21) Appl. No.: 19/096,849

(22) Filed: Apr. 1, 2025

(30) Foreign Application Priority Data
Apr. 3, 2024 (TW) 113112762

(51) Int. Cl. B60B 27/04; B60B 27/02

(52) U.S. Cl. CPC B60B 27/047; B60B 27/023; B60Y 2200/13

(57) ABSTRACT

A hub device includes: a hub shell, teeth on the hub shell, and at least one flange on the hub shell; a ratchet ring including a driving end portion inserted in the hub shell and including two grooves and recesses; detent members respectively received in the recesses and swingably engaged with the teeth; two elastic members having different elastic restraint force and circumferentially hooped around the detent members so that the detent members are engaged with the teeth; and a shaft disposed through the hub shell and the ratchet ring. Two ends of each of the elastic members are circumferentially limited at two opposite sides of a protruding member on the ratchet ring, and the two ends of each of the elastic members are movable away from or close to the protruding member in a circumferential direction of the ratchet ring.

### BACKGROUND OF THE INVENTION

### Field of the Invention

The present invention relates to a bicycle component, particularly to a hub device.

### Description of the Prior Art

Due to environmental protection, energy conservation, carbon reduction, or health considerations, many people have shifted from using motorcycles or cars to riding bicycles. In addition to being eco-friendly, cycling also strengthens the body and relieves stress. Therefore, cycling is highly favored recently.

When a bicycle moves forward, the rider forces the pedals, causing the chainring to rotate. The chainring drives the freewheel via the chain, and the freewheel cooperates with the hub device to rotate the rim. The hub device generally includes a hub shell, a shaft, and a ratchet ring. The ratchet ring is mounted with a freewheel and connected to the hub shell to transmit force to the hub shell. The hub shell connects to and drives the rim via a plurality of spokes. The shaft penetrates the hub structure and acts as a key component, allowing the rim to rotate relatively. Thus, the hub device is a very important component of a bicycle.

However, in the conventional hub device, the hub shell, ratchet ring, and the driving detent members disposed between them have issues such as unstable assembly, insufficient structural strength, unsmooth one-way ratcheting, and low transmission efficiency.

The present invention is, therefore, arisen to obviate or at least mitigate the above-mentioned disadvantages.

### SUMMARY OF THE INVENTION

The main object of the present invention is to provide a hub device capable of more stable, effective, and reliable driving.

To achieve the above and other objects, a hub device including: a hub shell including an axial hole, a plurality of teeth arranged around the axial hole and extending axially, and at least one flange arranged around the axial hole and extending radially, the flange being configured to be connected with a plurality of spokes; a ratchet ring including a driving end portion axially inserted in the hub shell, an outer circumferential surface of the driving end portion including two grooves and a plurality of recesses extending axially; a plurality of detent members respectively received in the plurality of recesses and swingably engaged with the plurality of teeth in a one-way ratcheting manner, and swingable between an outer swung position and an inner swung position; two elastic members circumferentially hooped around the plurality of detent members so that the plurality of detent members are engaged with the plurality of teeth; and a shaft disposed through the hub shell and the ratchet ring; wherein when the plurality of detent members are at the outer swung position, an elastic restraint force of each of the elastic members ranges from 0.0561 kgf to 0.0828 kgf; when the plurality of detent members are at the inner swung position, the elastic restraint force of each of the elastic members ranges from 0.09945 kgf to 0.13685 kgf; wherein each of the plurality of detent members includes two slots, the two elastic members are C-shaped members respectively received in the two slots, each of the two grooves is provided with a protruding member, two ends of each of the elastic members are circumferentially limited at two opposite sides of the protruding member on the ratchet ring, the two ends of each of the elastic members are free ends, and the two ends of each of the elastic members are movable away from or close to the protruding member in a circumferential direction of the ratchet ring.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is an enlarged view of FIG. 2;

FIG. 4 is a partial cross-sectional view showing a state where the driving end portion of the ratchet ring has not yet been inserted in the hub shell;

FIGS. 5 to 6 are operational diagrams of an exemplary embodiment of the present invention; and

FIG. 7 is an enlarged view of FIG. 4.

### DETAILED DESCRIPTION OF THE PREFERRED EMBODIMENTS

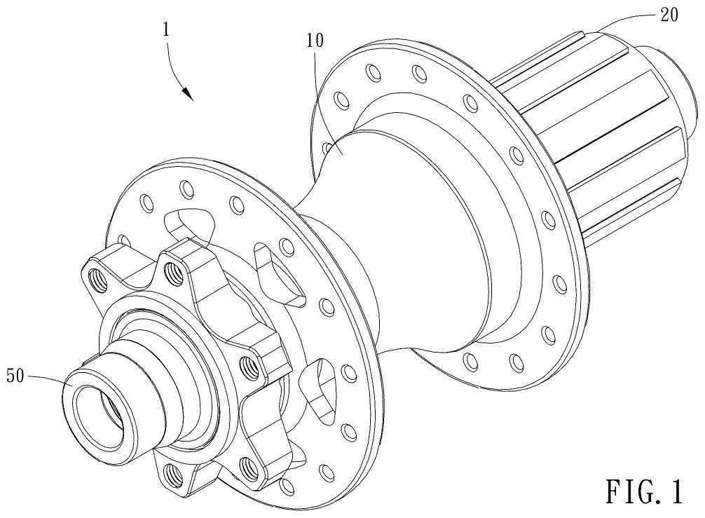

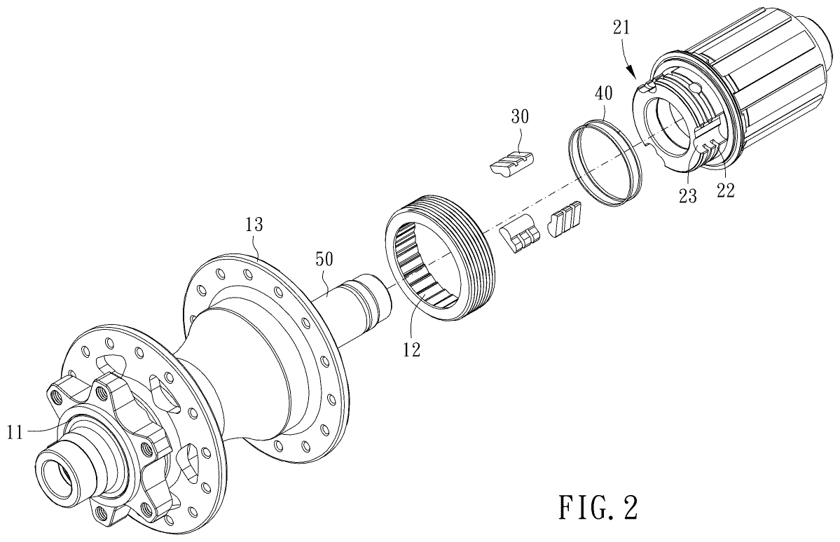

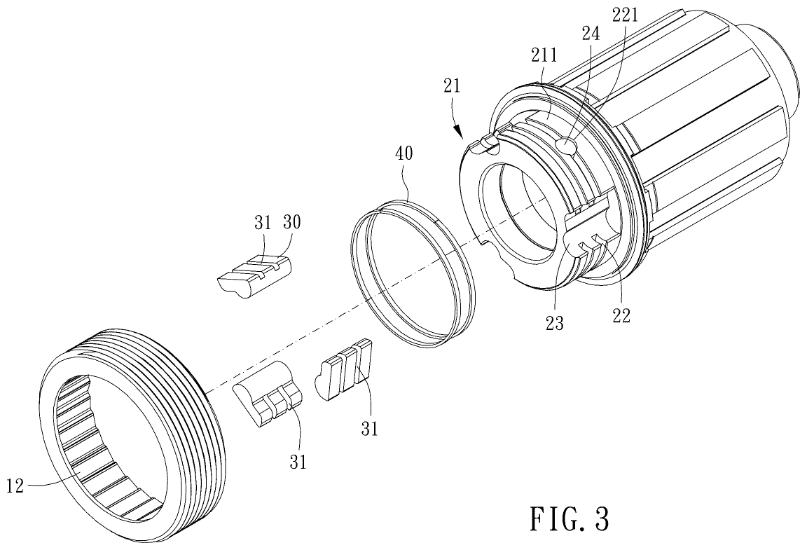

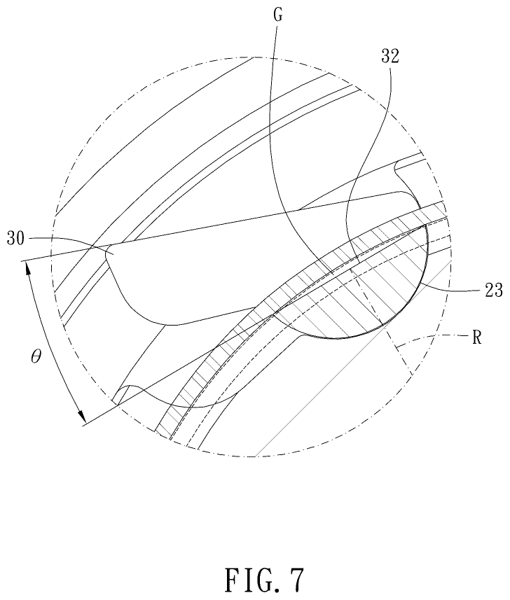

Please refer to FIGS. 1 to 7 for an exemplary embodiment of the present invention. A hub device 1 of the present invention includes a hub shell 10, a ratchet ring 20, a plurality of detent members 30, two elastic members 40 and a shaft 50.

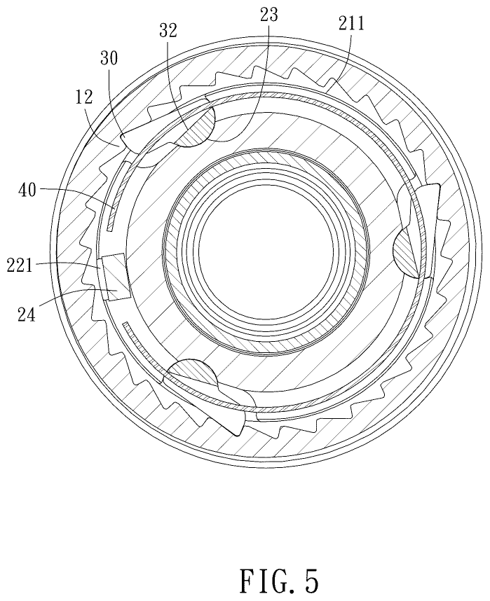

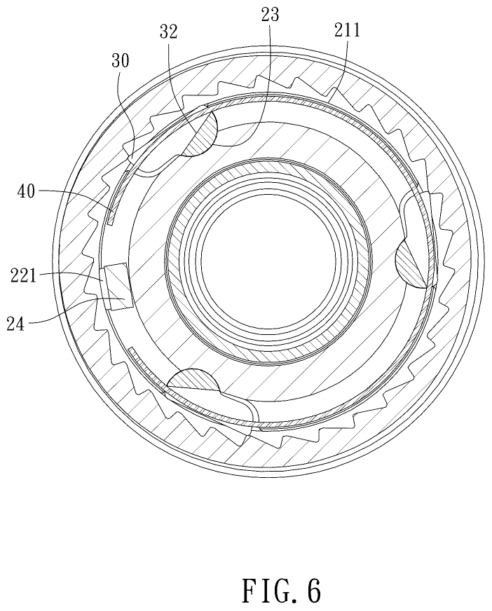

The hub shell 10 includes an axial hole 11, a plurality of teeth 12 arranged around the axial hole 11 and extending axially, and at least one flange 13 arranged around the axial hole 11 and extending radially. The flange 13 is configured to be connected with a plurality of spokes. The ratchet ring 20 includes a driving end portion 21 axially inserted in the hub shell 10. An outer circumferential surface 211 of the driving end portion 21 includes two grooves 22 and a plurality of recesses 23 extending axially. The plurality of detent members 30 are respectively received in the plurality of recesses 23 and swingably engaged with the plurality of teeth 12 in a one-way ratcheting manner. Each of the plurality of detent members 30 is swingable between an outer swung position (FIG. 5) and an inner swung position (FIG. 6). The two elastic members 40 are circumferentially hooped around the plurality of detent members 30 such that the detent members 30 are normally engaged with the teeth 12. Thus, the ratchet ring 20 can drive the hub shell 10 via the detent members 30, while allowing relative one-way rotation between the hub shell 10 and the ratchet ring 20. The shaft 50 is disposed through the hub shell 10 and the ratchet ring 20.

When the detent members 30 are at the outer swung position (FIG. 5, engaged with the teeth 12), the elastic restraint force of each of the elastic members 40 ranges from 0.0561 kgf to 0.0828 kgf. When the detent members 30 are at the inner swung position (FIG. 6, disengaged from the teeth 12), the elastic restraint force of each of the elastic members 40 ranges from 0.09945 kgf to 0.13685 kgf. Preferably, when the detent members 30 are at the outer swung position, the elastic restraint force of each of the elastic members 40 ranges from 0.066 kgf to 0.072 kgf, and when the detent members 30 are at the inner swung position, the elastic restraint force ranges from 0.117 kgf to 0.119 kgf. Thus, the detent members 30 are restrained with sufficient force, enabling stable swinging and reliable engagement with the teeth 12 for more efficient driving of the hub shell 10.

Specifically, the two elastic members 40 are C-shaped members. A density of each of the elastic members 40 ranges from 0.306 kg/mm to 0.04485 kg/mm. Preferably, the density of each of the elastic members 40 ranges from 0.036 kg/mm to 0.039 kg/mm. As such, it provides even force, appropriate elasticity, and structural stability.

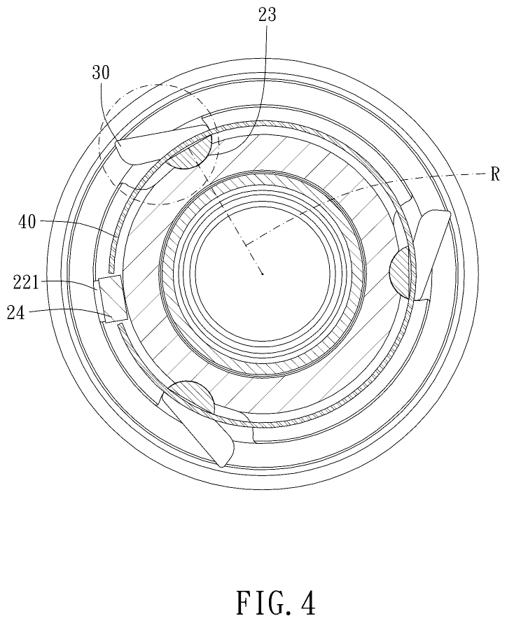

Specifically, each of the plurality of detent members 30 includes two slots 31. The two elastic members 40 are respectively received in the two slots 31. Each of the slots 31 includes a bottom side 32. When the detent members 30 are at the outer swung position or the inner swung position, the bottom side 32 of each of the slots 31 is located below the outer circumferential surface 211 of the driving end portion 21 relative to a bottom side of the recess 23. Thus, the two elastic members 40 do not protrude beyond the outer circumferential surface 211 of the driving end portion 21, allowing smooth engagement and disengagement between the detent members 30 and the teeth 12. In this embodiment, the bottom side 32 of each of the slots 31 is a flat surface. When the detent members 30 are at the outer swung position, each of the two elastic members 40 abuts an edge of the flat surface and there is a gap G between the elastic member and the flat surface. This improves the effectiveness and accuracy of the elastic force exerted on the detent members 30. In a state where the driving end portion 21 is not inserted in the hub shell 10 (see FIG. 4), the bottom side 32 of each of the slots 31 is perpendicular to a radial direction R of the shaft 50. Preferably, an included angle θ between the bottom side 32 of each of the slots 31 and an outer top surface ranges from 25 degrees to 35 degrees, which allows the detent members 30 to swing more smoothly and compactly.

In this embodiment, each of the two grooves 22 is provided with a protruding member 24. The protruding members 24 in the two grooves 22 are arranged at a 90-degree angle (may be other angles). Two ends of each of the elastic members 40 are free ends and are movable away from or close to the protruding member 24 in a circumferential direction of the ratchet ring 20. The two ends of each of the elastic members 40 are circumferentially limited at two opposite sides of the protruding member 24 to prevent rotation or displacement of the elastic members 40. Specifically, a bottom side of each of the two grooves 22 includes an insertion hole 221, and the protruding member 24 is inserted in the insertion hole 221, which facilitates quick and easy assembly and disassembly. Preferably, the diametric dimension of the protruding member 24 and the diametric dimension of the insertion hole 221 are greater than a width of each of the two grooves 22, which provides good structural strength and prevents deformation or deflection of the protruding member 24 under external force. The protruding member 24 may also be integrally formed with the driving end portion 21.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A hub device including:
a hub shell including an axial hole, a plurality of teeth arranged around the axial hole and extending axially, and at least one flange arranged around the axial hole and extending radially, the flange being configured to be connected with a plurality of spokes;
a ratchet ring including a driving end portion axially inserted in the hub shell, an outer circumferential surface of the driving end portion including two grooves and a plurality of recesses extending axially;
a plurality of detent members respectively received in the plurality of recesses and swingably engaged with the plurality of teeth in a one-way ratcheting manner, and swingable between an outer swung position and an inner swung position;
two elastic members circumferentially hooped around the plurality of detent members so that the plurality of detent members are engaged with the plurality of teeth; and
a shaft disposed through the hub shell and the ratchet ring;
wherein when the plurality of detent members are at the outer swung position, an elastic restraint force of each of the elastic members ranges from 0.0561 kgf to 0.0828 kgf;
when the plurality of detent members are at the inner swung position, the elastic restraint force of each of the elastic members ranges from 0.09945 kgf to 0.13685 kgf;
wherein each of the plurality of detent members includes two slots, the two elastic members are C-shaped members respectively received in the two slots, each of the two grooves is provided with a protruding member, two ends of each of the elastic members are circumferentially limited at two opposite sides of the protruding member on the ratchet ring, the two ends of each of the elastic members are free ends, and the two ends of each of the elastic members are movable away from or close to the protruding member in a circumferential direction of the ratchet ring.

2. The hub device of claim 1, wherein when the plurality of detent members are at the outer swung position, the elastic restraint force of each of the elastic members ranges from 0.066 kgf to 0.072 kgf, and when the plurality of detent members are at the inner swung position, the elastic restraint force of each of the elastic members ranges from 0.117 kgf to 0.119 kgf.

3. The hub device of claim 1, wherein the two elastic members are C-shaped members, and a density of each of the elastic members ranges from 0.306kg/mm to 0.04485 kg/mm.

4. The hub device of claim 3, wherein the density of each of the elastic members ranges from 0.036 kg/mm to 0.039 kg/mm.

5. The hub device of claim 1, wherein each of the two slots includes a bottom side, and when the plurality of detent members are at the outer swung position or the inner swung position, the bottom side of each of the slots is located below the outer circumferential surface of the driving end portion relative to a bottom side of one of the plurality of recesses.

6. The hub device of claim 5, wherein the bottom side of each of the two slots is a flat surface, and when the plurality of detent members are at the outer swung position, each of the two elastic members abuts an edge of the flat surface and there is a gap between the flat surface and the elastic member.

7. The hub device of claim 5, wherein, in a state where the driving end portion is not inserted in the hub shell, the bottom side of each of the two slots is perpendicular to a radial direction of the shaft.

8. The hub device of claim 1, wherein a bottom side of each of the two grooves includes an insertion hole, and the protruding member is inserted in the insertion hole.

9. The hub device of claim 6, wherein when the plurality of detent members are at the outer swung position, the elastic restraint force of each of the elastic members ranges from 0.066 kgf to 0.072 kgf; when the plurality of detent members are at the inner swung position, the elastic restraint force of each of the elastic members ranges from 0.117 kgf to 0.119 kgf; the two elastic members are C-shaped members, and a density of each of the elastic members ranges from 0.306 kg/mm to 0.04485 kg/mm; in a state where the driving end portion is not inserted into the hub shell, the bottom side of each of the two slots is perpendicular to a radial direction of the shaft; each bottom side of the two grooves includes an insertion hole, and the protruding member is inserted in the insertion hole; a diametric dimension of the protruding member and a diametric dimension of the insertion hole are greater than a width of each of the two slots; and an included angle between the bottom side of each of the slots and an outer top surface ranges from 25 degrees to 35 degrees.
